(19) United States
(12) Patent Application Publication
(10) Pub. No.: US 2005/0072650 A1
(43) Pub. Date: Apr. 7, 2005

(54) METHOD FOR TRANSPORTING PLASTIC PELLETS

(75) Inventors: Timothy J. Barror, Earlton, NY (US); Patrick S. Moore, Selkirk,, NY (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/605,467

(22) Filed: Oct. 1, 2003

(51) Int. Cl. B65G 11/00

(52) U.S. Cl. 193/27

(57) ABSTRACT

A system and method for transporting plastic pellets. In one embodiment the method for transporting plastic pellets comprises: moving plastic pellets through a conduit from an inlet to an outlet, wherein the conduit has an inner surface having sufficient topography to cause the plastic pellets to tumble.

### BACKGROUND OF THE INVENTION

The dispersed phase transfer method for plastic pellets includes conveying the pellets by blowing the pellets from an extruder through a transport pipe into a container such as a holding bin. When plastic pellets such as pellets formed from polyphenylene ether resin, are ejected from an extruder into the transport pipe, the pellets are floating in an air medium, and tend to drag against the walls of the transport pipe, causing friction that tends to smear the pellets. The smeared resin forms a “skin” and/or “strings” on the inside surfaces of the transfer line. The skin and/or strings can be sloughed off of the transfer pipe surface by new pellets traveling down the line, with the result that skins and/or strings end up in the product. Production must sometimes be shut down in order to wash the transfer lines, resulting in a delay in production. In addition, skins and/or strings may clog filters on dryers and molding machines.

Thus, a need exists for new methods for transporting plastic pellets without smearing the pellets.

### BRIEF DESCRIPTION OF THE INVENTION

Disclosed herein are a system and method for transporting plastic pellets. In one embodiment the method for transporting plastic pellets comprises: moving plastic pellets through a conduit from an inlet to an outlet, wherein the conduit has an inner surface having sufficient topography to cause the plastic pellets to tumble.

The above described and other features are exemplified by the following detailed description.

### DETAILED DESCRIPTION OF THE INVENTION

Disclosed herein is a method for transporting plastic pellets through a tubular pipe, preferably reducing or eliminating the smearing of the pellets, thereby reducing or eliminating the formation of “skin” and/or “strings” on the inside surfaces of the transfer line, and reducing the occurrence of skins in the product. This method reduces or eliminates the possibility of skins from previous grades getting into a new grade of plastic pellet moved through the same tubular pipe.

The method includes moving (e.g., by use of a vacuum system, suction, ejecting, blowing, and/or expelling) the plastic pellets through a conduit (e.g., a pipe) having an inner surface topography comprising a groove, thread, protuberance, indentation or combinations of two or more of the foregoing thus enabling the pellets to move through the pipe without forming skins and/or strings. For example, the conduit may have a substantially cylindrical body, wherein the cylindrical body defines a channel having an inlet, an outlet, and an inner surface, with a spiral geometry (e.g., groove(s), thread(s), indentations and/or protuberances) formed on (e.g., on/into) at least a portion of the inner surface. The pellets move through the channel from the inlet to the outlet. Alternatively, the grooves, thread and/or protuberances may be randomly arranged or arranged in a non-spiral ordered fashion such as concentrically.

The width of the grooves or indentations, or the height of the threads or protuberances on the inner surface of the conduit may be any sufficient depth or height, respectively, as well as any pitch and frequency, to attain the desired motion of the pellets through the conduit such that smear and the formation of skins and strings is avoided. The width of the grooves or indentations or the height of the threads or protuberances as well as spacing between the groove, indentations, threads and/or protuberances should be sufficient to cause the majority of the pellets to tumble without resulting in accumulation or blockage. In some embodiments the width of the grooves or indentations or the height of the threads or protuberances is about 0.79 to 3.17 millimeters. The width of the grooves or indentations or the height of the threads or protuberances may vary throughout the length of the conduit. In one embodiment, the width of the grooves or indentations or the height of the threads or protuberances is about 10 to about 100 percent, preferably about 20 to about 50 percent, of the longest average linear dimension of the pellet.

Preferably the transported pellets comprises less than or equal to about 0.5 weight percent, more preferably less than or equal to about 0.3 weight percent, and most preferably less than or equal to about 0.3 weight percent skins and strings based on the total weight of the transported pellets.

The design of the geometry (e.g., the depth and arrangement of the grooves and/or indentations, the height and arrangement of the threads and/or protuberances) is sufficient to cause the pellets to tumble rather than slide, thereby reducing friction and enabling a decreased amount of sliding movement of the pellets through the conduit, including bends and elbows therein. While not being limited by theory, it is hypothesized that heat created by the friction from pellets sliding along the inside surface of the channel is responsible, at least in part, for pellets smearing. Creation of a tumbling motion reduces or eliminates the amount of friction, thereby reducing or eliminating pellet smearing.

The specific dimensions of the conduit and the design of the geometry are sufficient for the particular application (e.g., pellet flow rate, etc.). For example, an inner conduit diameter may be about 1 inch (about 2.54 centimeters (cm)) to about 10 inches (about 25.4 cm), with a diameter of about 4 inches (about 10.2 cm) to about 6 inches (about 15.2 cm) possible. The length of the pipe can be any length suitable for use in a transfer system capable of forcing the pellets through the length of pipe, e.g., the length can be up to and exceeding 50 feet, with a conduit length of about 80 feet to about 200 feet common for use with this process.

The conduit may comprise a material compatible with the particular pellet and having sufficient structural integrity and durability. Possible materials include metals (such as stainless steel, copper, aluminum, and the like, as well as combinations and alloys comprising at least one of the foregoing metals). The piping may be rigid or flexible. As the term is used herein, “rigid” refers to a material that is not bent or deformed as the pellets are transferred through the pipe. As the term is used herein, “flexible” refers to a material that can bend or be deformed as the pellets are transferred through the pipe.

The conduit geometry and design is based upon the particular application. For example, the conduit can be substantially cylindrical, and can be straight or can comprise straight, curved, and/or elbow portions (e.g., turns in the conduit that can up to a 90° bend in the conduit). It is preferable that the grooves, threads, indentations and/or protuberances be disposed throughout the conduit from the inlet, through any bends, elbows, and/or curves, to the outlet. By “substantially cylindrical” is meant that the tube body does not have constrictions or increases in diameter that would affect the movement of pellets through the non-straight portions.

The term “pellet” as used herein refers to particles that are larger than “powders”. By way of illustration, the pellets may have at least one dimension that is greater than or equal to about 0.5 millimeter to about 5 millimeters. Possible pellets include pelletized extrudate, e.g., blown from an extruder through the conduit to a storage or other area.

The method has been found particularly useful with plastic pellets having a scratch resistance, as measured in scratch depth, of about 800 micrometers to about 7,000 micrometers. The plastic pellets comprise a thermoplastic resin such as poly(arylene ether), polyamides, polyimides (e.g., polyetherimide, and the like), polystyrenes, polycarbonates, and the like, as well as combinations and reaction products comprising at least one of the foregoing resins, such as poly(arylene ether)/polyamide compatibilized blends, poly(arylene ether)/polystyrene blends, and polycarbonate blends. In one embodiment the plastic pellets comprise poly(arylene ether) and less than or equal to about 5 weight percent polyolefin based on the total weight of the composition. A typical plastic pellet suitable for use in the disclosed method is Noryl GTX® resin (GE Plastics).

In order to further reduce the potential formation of skins and strings as well as to inhibit smear, the conduit temperature can be maintained below the softening point of the pellet. For example, the temperature can be maintained at a temperature of less than or equal to about 170° C., with less than or equal to about 160° C. preferred. In operation, the temperature of the conduit can be maintained at about 100° C. to about 170° C., with about 100° C. to about 130° C. preferably employed throughout the conduit. To help insure the integrity of the pellets, maintenance of the temperature at less than or equal to about 50° C. below the glass transition temperature of the pellet is preferred.

### EXAMPLES

Plastic pellets were moved through a pipe having a smooth internal surface (smooth) or a spiral groove on the internal surface (spiral) with a terminal velocity of 1829 meters/minute. The plastic pellets had an average longest linear dimension of about 3.17 millimeters. The groove in the pipe had a width of about 0.79 to 3.17 millimeters. The composition of the plastic pellets as well as the presence or absence of skins and strings is shown in Table 1.

TABLE 1

| Pellet Composition | Smooth conduit | Spiral conduit |
|---|---|---|
| Poly(arylene | Skin | No skin |
| ether)/polyamide | | |
| blend | | |
| Poly(arylene | Skin | No skin |
| ether)/polypropylene | | |
| blend | | |

Conduits having the interior spiral geometry substantially reduced skins and strings therein during the transfer of pellets. This system and method prevents or minimizes a condition of abraded plastic material buildup in the form of skins or strings in conduits (e.g., pipes) used to transport the pellets, and also reduces or eliminates contamination of the product with skins or strings. The method enables transport of plastic pellets without stoppage of pellet flow for cleaning the transfer lines, and with minimal maintenance of the transfer lines and equipment. This enables the pellets to be continuously moved through the channel from the inlet to the outlet.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for transporting plastic pellets comprising moving plastic pellets through a conduit from an inlet to an outlet wherein the conduit has an inner surface with sufficient topography to cause substantially of all of the plastic pellets to tumble, wherein the inner surface topography comprises a groove, thread, protuberance, indentation or combination of two or more of these topographical features.

2. The method of claim 1 wherein the topography comprises a groove, thread, protuberance, indentation, or combination of two or more of the foregoing.

3. The method of claim 2 wherein the groove, thread, protuberance, indentation, or combination of two or more of the foregoing is arranged in a spiral geometry.

4. The method of claim 2 wherein the groove, thread, protuberance, indentation, or combination of two or more of the foregoing is randomly arranged.

5. The method of claim 2 wherein the groove, thread, protuberance, indentation, or combination of two or more of the foregoing is arranged in a non-spiral ordered fashion.

6. The method of claim 2 wherein the groove and/or indentation has a width that is about 10 to about 50 percent of the longest average linear dimension of the plastic pellets.

7. The method of claim 2 wherein the thread and/or protuberance has a height that is about 10 to about 50 percent of the longest average linear dimension of the plastic pellets.

8. The method of claim 1 wherein the transported pellets comprise less than or equal to about 0.5 weight percent skins and strings based on the total weight of the transported pellets.

9. The method of claim 1 wherein the conduit comprises a metal.

10. The method of claim 1 wherein the conduit is rigid.

11. The method of claim 1 wherein the conduit is flexible.

12. The method of claim 1 wherein the plastic pellets comprise poly(arylene ether), polyamide, polyimide, polystyrene, polycarbonate and combinations of two or more of the foregoing resin.

13. The method of claim 1 wherein the conduit is maintained at a temperature of about 100 to about 170° C.

14. The method of claim 1 wherein the conduit is maintained at a temperature less than or equal to about 50° C. below the glass transition temperature of the plastic pellet.

15. A method for transporting plastic pellets comprises: moving pellets comprising poly(arylene ether) and polyamide through a conduit from an inlet to an outlet, wherein the conduit has an inner surface comprising a groove, thread, protuberance, indentation or combination of two or more of the foregoing and the transported pellets contain less than or equal to about 0.5 weight percent skins and strings, based on the total weight of the transported pellets.
